(19) United States
(12) Patent Application Publication
(10) Pub. No.: US 2012/0050539 A1
(43) Pub. Date: Mar. 1, 2012

(54) CAMERA HAVING A TEMPERATURE BALANCING FEATURE

(76) Inventors: Eyal Naimi, Jerusalem (IL); Yoel Arieli, Jerusalem (IL); Israel Boaz Arnon, Neve Tsuf (IL)

(21) Appl. No.: 13/319,087

(22) PCT Filed: May 5, 2010
(86) PCT No.: PCT/IL10/00365

§ 371 Date: Nov. 6, 2011

Related U.S. Application Data
(60) Provisional application No. 61/213,094, filed on May 6, 2009.

(51) Int. Cl. H04N 5/33; H04N 5/225

(52) U.S. Cl. 348/164; 348/335; 348/E05.026; 348/E05.09

(57) ABSTRACT

A camera system is provided. The camera system includes an optical sensing unit which is surrounded by a camera housing and at least one temperature balancing fixture which is in thermal contact with a surface of the camera housing The temperature balancing fixture is configured for maintaining symmetrically-opposed regions on the surface of the camera housing at a substantially similar temperature.

### RELATED APPLICATION/S

This application claims the benefit of priority from U.S. Application No. 61/213,094 filed May 6, 2009, the contents of which are hereby incorporated by reference.

### FIELD AND BACKGROUND OF THE INVENTION

The present invention relates to a camera having a housing which includes a temperature balancing fixture.

The market for infrared cameras is large, and growing quickly, driven largely by medical and security applications. Several types of imaging systems are used to observe wavelengths in the infra red range. Such systems employ expensive cryogenically-cooled detection arrays, to the more recent un-cooled microbolometer arrays.

For security applications infra red imaging can be carried out using the relatively inexpensive non-cooled arrays, however, medical applications require highly accurate and sensitive arrays which are expensive to produce and operate.

Medical applications of infrared imaging technologies include, for example, diagnosis of a thermally distinguishable site in a human body which can be related to a pathology. Infrared cameras produce two-dimensional images known as thermographic images. A thermographic image is typically obtained by collecting from a body of the subject radiation at any one of several infrared wavelength ranges and analyzing the radiation to provide a two-dimensional temperature map of the surface. The thermographic image can be represented as a visual image with or without corresponding temperature data. The output from infrared cameras used for infrared thermography typically provides an image comprising a plurality of pixel data points, each pixel providing temperature information which is visually displayed, using a color code or grayscale code. The temperature information can be further processed by computer software to generate for example, mean temperature for the image, or a discrete area of the image, by averaging temperature data associated with all the pixels or a sub-collection thereof.

Thus, in medical applications it is important to obtain a temperature map that accurately represents the tissue examined, even slight variations in readings or environmentally produced artifacts can result in misdiagnosis. For example, fluctuations in temperature can negatively affect infrared imaging devices; temperature gradients which exist within an optical or sensor array component of an infra red (IR) camera, can lead to significant deterioration of the image produced by the camera.

Several attempts have been made to try and solve these problems. For example, U.S. Pat. No. 7,329,869 discloses an infrared camera system which includes a thermal equalizer which is designed for conducting heat energy from warmer to cooler parts of the optics/sensor unit.

Although the above described system can conduct heat away from the camera sensor unit, it does not enable temperature equalization across the sensor array and thus can be limited when used in medical applications.

The present invention provides a system which can be used to actively equilibrate temperature across a camera sensor array thus substantially reducing thermal artifacts in captured images.

### SUMMARY OF THE INVENTION

According to one aspect of the present invention there is provided camera system comprising an optical sensor array being surrounded by a camera housing and at least one temperature balancing fixture being in thermal contact with a surface of the camera housing, the temperature balancing fixture being for maintaining a temperature gradient on the surface of the camera housing selected suitable for maintaining symmetrically opposed ends of the optical sensor array at the same temperature.

According to further features in preferred embodiments of the invention described below, the optical sensor array is an infra red sensor array.

According to still further features in the described preferred embodiments the at least one temperature balancing fixture includes cooling fins, a temperature controller and a thermal electric element.

According to still further features in the described preferred embodiments the thermal electric element is disposed between the housing and the cooling fins.

According to still further features in the described preferred embodiments the temperature controller is for maintaining a temperature of the thermal electric element.

According to still further features in the described preferred embodiments the thermal electric element is capable of electric cooling and/or heating.

According to still further features in the described preferred embodiments a temperature of the thermal electric element is maintained at 0.1-2° C. above or below a temperature of the housing.

According to still further features in the described preferred embodiments the camera system includes four temperature balancing fixtures each being in thermal contact with a specific panel of the camera housing.

According to still further features in the described preferred embodiments the camera further comprises an isolation package being disposed between the thermal electric element and the cooling fins.

According to still further features in the described preferred embodiments the camera further comprises at least one additional temperature balancing fixture being in thermal contact with the optical sensing unit.

According to still further features in the described preferred embodiments at least one of the four temperature balancing fixtures is designed for maintaining a temperature below or above the remaining temperature balancing fixtures of the four temperature balancing fixtures.

According to still further features in the described preferred embodiments at least one of additional temperature balancing fixture is in thermal contact with the optical sensing unit and is designed for maintaining a temperature below or above the remaining temperature balancing fixtures.

According to still further features in the described preferred embodiments the at least one temperature balancing fixture includes a temperature controller and a thermal electric element capable of electric heating.

According to another aspect of the present invention there is provided a method of equilibrating a temperature across an optical sensor array of a camera, the method comprising actively cooling and/or heating at least one surface of a housing of the camera thereby equilibrating the temperature across the sensor array.

According to still further features in the described preferred embodiments the actively cooling and/or heating is effected by at least one temperature balancing fixture.

According to still further features in the described preferred embodiments the at least one temperature balancing fixture is in thermal contact with a surface of the housing.

According to still further features in the described preferred embodiments the at least one temperature balancing fixture includes cooling fins, a temperature controller and a thermal electric element.

According to still further features in the described preferred embodiments the thermal electric element is capable of electric heating and/or cooling.

According to still another aspect of the present invention there is provided a thermal stabilizing system comprising at least one temperature balancing fixture being configured for attachment to a surface of a camera housing, the temperature balancing fixture being for maintaining symmetrically-opposed regions on the surface of the camera housing at a substantially similar temperature.

According to still another aspect of the present invention there is provided a thermal stabilizing system comprising at least one temperature balancing fixture for maintaining different regions on the surface of the camera housing at different temperatures.

According to still further features in the described preferred embodiments the temperature balancing fixtures are controlled and manipulated according to the environment conditions.

According to still further features in the described preferred embodiments the temperature balancing fixtures are controlled and manipulated in time according to the drift conditions of the detectors.

According to still further features in the described preferred embodiments the temperature balancing fixtures are controlled and manipulated in time according to a given feedback.

According to still further features in the described preferred embodiments the at least one of said temperature balancing fixtures is placed in at the field of view of at least one of said IR sensors in order to be used as a reference temperature target.

The present invention successfully addresses the shortcomings of the presently known configurations by providing a retrofit device for uniformly cooling digital cameras such as IR cameras.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A schematically illustrates the components of a standard non-modified digital camera.

FIG. 1B schematically illustrates the components of the system of the present invention as mounted on the camera of FIG. 1a.

FIG. 2 is a thermal map obtained from the sensor array of a non-modified thermal camera

FIG. 3 is a thermal map obtained from the sensor array of a thermal camera modified to include the system of the present invention.

### DESCRIPTION OF THE PREFERRED EMBODIMENTS

The present invention is of a camera having a housing adapted for temperature balancing. Specifically, the present invention can be used to balance a temperature over a housing of an infra red camera thereby balancing the temperature across the infra red radiation detector array.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Fluctuations in temperature can limit the accuracy of image capture devices and in particular IR cameras. A temperature gradient across an infrared sensor array of a camera can lead to image artifacts and thus severely limit the use of such cameras especially in medical diagnostic applications.

While reducing the present invention to practice, the present inventors have constructed a system which can be used to stabilize the temperature across an optical sensor array. Such a system can be used to rapidly and accurately respond to any fluctuations in temperature within or around the camera and thus it can be used to maintain temperature uniformity throughout an optical sensor array such as an IR sensor array and minimize any image artifacts.

Thus according to one aspect of the present invention there is provided a thermal stabilization system which can be used to equilibrate a temperature throughout an optical sensor array of a camera such as a CCD or CMOS camera. Specifically, the present system can be used to equilibrate a temperature throughout an optical sensor array of an infra red imaging device (IR camera).

The system of the present invention includes at least one temperature balancing fixture which is configured for attachment to any camera component, including, for example, an internal or external surface of the camera housing.

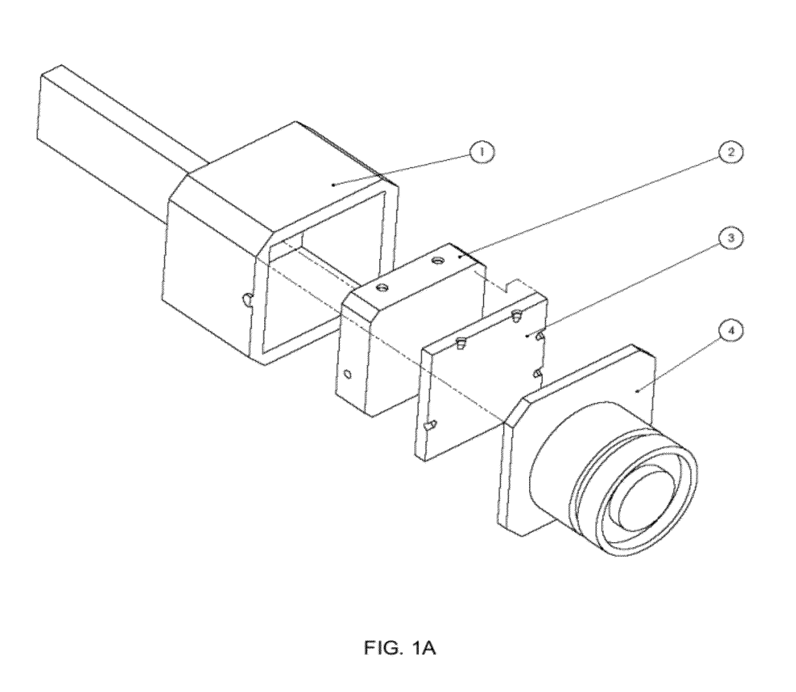

Components of a camera are illustrated in FIG. 1a. The camera includes a camera housing (1) an optics package (4), a sensing array (3) and a processing unit/electronics package (2).

The temperature balancing fixture of the present invention includes a temperature controller and a thermal element such as thermal electric element. The temperature balancing fixture can also include cooling fins which are in thermal contact with the thermal electric element.

The thermal electric element can function as a thermal electric cooler (e.g. a Peltier device); and/or it can function as a thermal electric heating device (e.g. heating coil etc). In any case, the temperature controller is used to set the desired function (heating or cooling or combination) of the thermal electric element according to input received from temperature sensors positioned in the environment and in or on the camera and a preprogrammed algorithm designed for temperature corrections.

Thus, the temperature controller is used to control the thermal electric element which functions in cooling or heating a specific camera component. The cooling fins can be used to increase the surface area of the thermal electric element and thus allow faster dissipation of thermal energy from the thermal electric element when used in cooling.

The position and function of the temperature balancing fixture is selected according to its effect on the optical sensor array. For example, when positioned on a surface of the camera housing, the temperature balancing fixture is set so as to maintain a temperature gradient on the surface of said camera housing which is results in an no appreciable temperature differential in two symmetrically-opposed ends or regions of the optical sensor array. In other words, the position and function of the temperature balancing fixture are selected according to their affect on the temperature distribution on the optical sensor array.

Several factors have to be taken into consideration when setting the position and function (temperature differential with respect to camera and environment, heating or cooling) of each temperature balancing fixture: the size of the cooling/heating elements and cooling fins, the size of the array and camera housing, the type of camera, the operating temperature of the camera and the environment its employed in and the work load of the camera.

Each of these factors can influence the type, number and individual size of each of the temperature balancing fixtures used. For example, if the work load of the camera is small (e.g. operates an hour a day) and it is employed in a controlled environment having a relatively fixed temperature, then two temperature balancing fixture with cooling elements and cooling fins can be used to maintain the same temperature at symmetrically opposed regions.

As is mentioned hereinabove, maintaining the same temperature at symmetrically opposed regions of an optical sensor array and indeed maintaining the same temperature throughout the array is necessary in order to eliminate artifacts which can arise from temperature gradient across the array.

In order to maintain such uniform temperature and rapidly correct for fluctuations during camera operation, two or more temperature balancing fixtures are utilized and coordination between the functions of the various fixtures is established and maintained preferably via a central controller.

Thus, preferably two or more temperature balancing fixtures are utilized (in coordination) in order to achieve rapid and stable temperature uniformity throughout the optical sensor array of the camera. In order to maintain such uniformity, the temperature of the camera (preferably the array) and the ambient temperature are periodically monitored and the operation of the temperature balancing fixtures is corrected (increasing/decreasing thermal gradients) if necessary.

FIG. 1b which is further described in the Examples section which follows, illustrates one embodiment of the system of the present invention as fitted on a standard uncooled camera. In this embodiment, two symmetrically opposed temperature balancing fixtures are shown, however, it should be noted that any number of fixtures (e.g. 1, 2, 3, 4, 5, 6, 7 or 8 or more), positioned at any locations in or on the camera housing can be used to achieve temperature uniformity throughout the optical sensor array of the camera.

It will be appreciated that the temperature balancing fixtures can be tested from time to time using a calibrated thermal target (e.g. diode array). Such a target can be photographed and used to test the uniformity of the camera array. The temperature balancing fixtures can then be calibrated accordingly to ensure thermal uniformity across the camera housing and components and uniformity of the array.

Thus, the present invention provides a system which can be used to equilibrate a temperature throughout an optical sensor array of a digital camera.

Such a system can be retrofitted onto any camera using an external jig for holding the temperature balancing fixture or by directly mounting the temperature balancing fixtures onto the camera housing adhesive or screws. In any case, thermal paste is preferably used at points of contact between the temperature balancing fixture and the housing of the camera in order to ensure good thermal conductivity. Alternatively, the temperature balancing fixtures can be integrated with camera components during camera assembly.

As used herein the term “about” refers to ±10%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### Example

Reference is now made to the following examples, which together with the above descriptions, illustrate the invention in a non limiting fashion.

Flatness Correction and Time Stabilization in a Thermal Imaging Camera

Uncooled thermal sensors produce non-uniform fields which result from variance in temperature across the sensor array. This variance in temperature is caused by asymmetrical temperature distribution within the camera housing.

The present inventors propose that a temperature balancing fixture (TBF) can be utilized to significantly decrease thermal noise and artifacts and enhance the uniformity of the thermal readout without having to cool the sensor array or housing.

While reducing the present invention to practice, the present inventors constructed a temperature balancing fixture (schematically shown in FIG. 1) and attached it to the outer housing surface of a thermal camera.

The TBF includes three main components, cooling fins, a temperature controller and a thermal electric element (Peltier plate). When arranged as shown in FIG. 1, the fixture enables a very slight temperature gradient between the camera housing and the surrounding environment. The TEC and thermal controller function in maintaining a temperature slightly lower than the housing (0.1-5° C.), while the cooling fins disperse thermal energy conducted from the housing to the environment.

Thus, the fixture functions in drawing heat away from the camera housing and dispersing it to the environment through the cooling fins. The biggest difference between this arrangement and thermal equalizers described in the prior art (e.g. U.S. Pat. No. 7,329,869) is that the present fixture does not cool the camera but rather functions in slowly draws heat away from the housing and as such it balances the temperature across the camera housing and across the sensor array.

The camera was used to image a black body while fitted with the temperature balancing fixture (modified camera) and the results were compared to images taken by the same camera while devoid of the fixture (non-modified camera).

FIG. 1 illustrates results obtained by the non-modified camera. Although the black body should provide a substantially uniform image map, the non-modified camera produced 25-30 temperature (grey) levels indicating a temperature range across the sensor of 2-2.5° C.

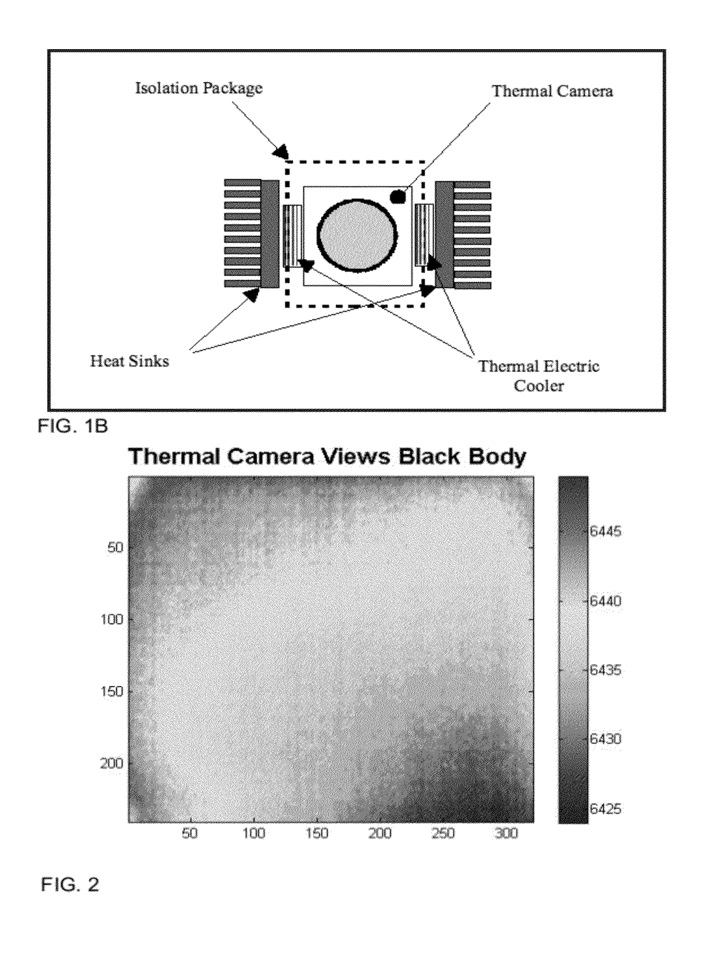

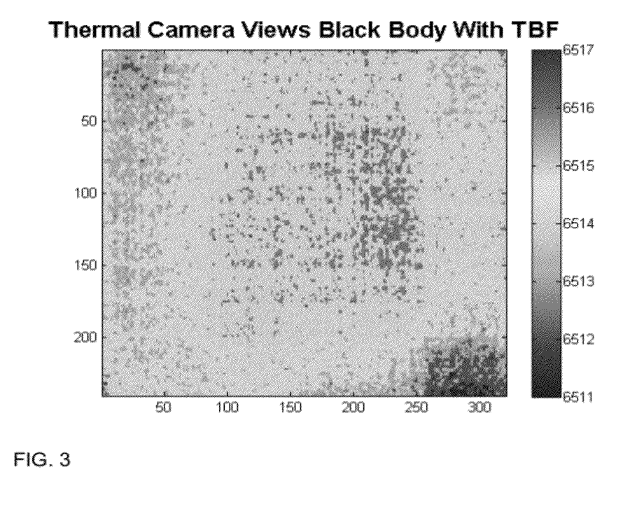

FIG. 2 illustrates results obtained by the modified camera. As is clearly illustrated by this Figure, the modified camera constructed in accordance with the teachings of the present invention obtains a thermal image which has only 6 levels of temperature. Since each discernable level equates to 80° mK, a non-modified camera will produce a variance of 2° C., while the modified camera will produce a variance of only 0.48° C.

The TBF can also be utilized to determine camera levels without time dependence. When in use, a temperature of a non-cooled thermal camera varies over time. As such, a non-cooled thermal camera has to be recalibrated at various time points. Since recalibration involves resetting of sensor temperature levels, such recalibration implies that a camera cannot be used to image a single target over long periods of time (hours). As is shown in FIG. 2, the TBF described herein maintains temperature uniformity across the sensor array and thus enables use of the camera throughout a greater working temperature range without having to re-calibrate the camera.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A camera system comprising an optical sensor array being surrounded by a camera housing and at least one temperature balancing fixture being in thermal contact with a surface of said camera housing.

2. The camera system of claim 1, wherein said temperature balancing fixture is configured for maintaining a temperature gradient on said surface of said camera housing selected suitable for maintaining symmetrically opposed ends of the optical sensor array at the same temperature.

3. The camera system of claim 1, wherein said optical sensor array is an infra red sensor array.

4. The camera system of claim 1, wherein said at least one temperature balancing fixture includes cooling fins, a temperature controller and a thermal electric element.

5. The camera system of claim 4, wherein said thermal electric element is disposed between said housing and said cooling fins.

6. The camera system of claim 4, wherein said temperature controller is for maintaining a temperature of said thermal electric element.

7. The camera system of claim 4, wherein said thermal electric element is capable of electric cooling and/or heating.

8. The camera system of claim 6, wherein a temperature of said thermal electric element is maintained at 0.1-2° C. above or below a temperature of said housing.

9. The camera system of claim 1, wherein the camera system includes four temperature balancing fixtures each being in thermal contact with a specific panel of said camera housing.

10. The camera system of claim 4, further comprising an isolation package being disposed between said thermal electric element and said cooling fins.

11. The camera system of claim 1, further comprising at least one additional temperature balancing fixture being in thermal contact with said optical sensing unit.

12. The camera system of claim 9, wherein at least one of said four temperature balancing fixtures is designed for maintaining a temperature below or above said remaining temperature balancing fixtures of said four temperature balancing fixtures.

13. The camera system of claim 1, wherein said at least one temperature balancing fixture includes a temperature controller and a thermal electric element capable of electric heating.

14. A method of equilibrating a temperature across an optical sensor array of a camera, the method comprising actively cooling and/or heating at least one surface of a housing of the camera thereby equilibrating the temperature across the sensor array.

15. The method of claim 14, wherein said actively cooling and/or heating is effected by at least one temperature balancing fixture.

16. The method of claim 15, wherein said at least one temperature balancing fixture is in thermal contact with a surface of said housing.

17. The method of claim 15, wherein said at least one temperature balancing fixture includes cooling fins, a temperature controller and a thermal electric element.

18. The method of claim 14, wherein said thermal electric element is capable of electric heating and/or cooling.

19. A thermal stabilizing system comprising at least one temperature balancing fixture being configured for attachment to a surface of a camera housing, said temperature balancing fixture being for maintaining symmetrically-opposed regions on said surface of said camera housing at a substantially similar temperature.
